(19) United States
(12) Patent Application Publication
(10) Pub. No.: US 2017/0127670 A1
(43) Pub. Date: May 11, 2017

(54) SEED COATING COMPOSITION

(71) Applicant: INCOTEC HOLDING B.V., ENKHUIZEN (NL)

(72) Inventors: AMY NICOLE BUENO, LAFAYETTE, IN (US); TERRY EUCLAIRE MEYER, WEST LAFAYETTE, IN (US); RENIL JOHN ANTHONY, WEST LAFAYETTE, IN (US)

(73) Assignee: INCOTEC HOLDING B.V., ENHUIZEN (NL)

(21) Appl. No.: 15/346,189

(22) Filed: Nov. 8, 2016

(30) Foreign Application Priority Data
Nov. 9, 2015 (EP) 15193624.2

(51) Int. Cl. A01N 25/10; A01N 25/24; A01N 63/00

(52) U.S. Cl. CPC A01N 25/10; A01N 63/00; A01N 25/24

(57) ABSTRACT

The invention is directed to an aqueous seed coating composition comprising one or more active ingredients, to a pre-blend and use thereof as a component of the seed coating composition, to a method for improving the bio-efficacy of an active ingredient in a seed coating, and to a coated seed.

The seed coating composition and/or pre-blend of the invention further comprise a wax, and at least one pigment.

### CROSS-REFERENCE TO RELATED APPLICATIONS

This application claims the benefit of European Application No. EP 15193624.2, filed 9 Nov. 2015, the disclosure of which is incorporated by reference in its entirety for all purposes.

The invention is directed to a seed coating composition comprising one or more active ingredients, to a pre-blend and use thereof as a component in the seed coating composition, to a method for improving the bio-efficacy of an active ingredient in a seed coating, and to a coated seed.

Plant seed is often coated before sowing, for example, to protect seeds from damage during handling and/or to improve handling properties. Seeds are often coated to provide useful substances (active ingredients) to the seed and the seedlings upon germination, for example, plant nutrients, growth stimulating agents, and plant protective products. An important advantage of providing active ingredients in a seed coating is that it allows for a precise and controlled release and dose per seedling. Typical seed coating methods include film coating, pelleting and encrusting of seed.

The seed coating can contain many ingredients, and each of these ingredients has their advantages and disadvantages. One of the disadvantages that may occur when applying active ingredients in a coating composition is that, depending on the nature of the coating, the type of active ingredient, and the solubility thereof, the active ingredient may be retained in the coating or released more slowly than required and the resulting efficacy of the active ingredient for the seed or plant may be decreased. In particular, the rise of hydrophobic and/or water insoluble active ingredients brings new challenges for formulators of seed coating compositions. The active ingredients should still have sufficient mobility in order to adequately perform their function, but on the other hand the seed coating itself should have the conventional and desirable seed coating properties, such as water permeability, and should not negatively affect seed germination.

Some attempts have been made in the art to include hydrophobic active ingredients in a seed coating.

WO-A-2001/010212, for instance, describes a composition that may comprise a hydrophobic active ingredient, wherein the composition is based on a water-in-oil polymer dispersion.

In spite of these prior attempts, there is still a need in the art to provide a seed coating composition which facilitates the overall movement of active ingredients, while preserving the usual important properties of the seed coating.

An object of the invention is to address this need in the art and overcome disadvantages of prior art seed coating compositions.

The inventors found that this object can, at least in part, be met by using special seed coating formulations as described herein.

Accordingly, in a first aspect the invention is directed to an aqueous seed coating composition comprising a wax, at least one pigment, an optional surface active agent and one or more biologically active ingredients.

In a second aspect, the invention is directed to an aqueous pre-blend comprising a wax, at least one pigment, and an optional surface active agent.

In a third aspect, the invention is directed to a method of forming a seed coating composition which comprises combining (i) an aqueous pre-blend comprising a wax, at least one first pigment, and an optional surface active agent, (ii) one or more biologically active ingredients, (iii) a dye and/or second pigment different to the first pigment, and (iv) optionally water.

In a fourth aspect, the invention is directed to a seed with a coating comprising a wax, at least one pigment, an optional surface active agent and one or more biologically active ingredients.

In a fifth aspect, the invention is directed to a method for improving the bio-efficacy and/or systemic uptake by plants of one or more active ingredients in a seed coating composition, comprising preparing a seed coating composition comprising a wax, at least one pigment, an optional surface active agent and one or more biologically active ingredients, and applying said seed coating composition to the seed.

### BRIEF DESCRIPTION OF THE DRAWINGS

FIG. 1 shows release patterns of hydrophobic insecticide in water measured on coated soybean seeds.

FIG. 2 shows release patterns of hydrophobic insecticides in water measured on coated corn seeds.

FIG. 3 shows a sampling procedure for 1^{st} frifoliate soybeans for a bioassay.

FIG. 4 shows a comparison of % leaf consumption of soybean leaf discs of various film-coats to that of untreated seeds and seeds treated with PPPs only.

FIGS. 5A to 5C show the numbering system for leaves and the sectioning system for bioassay.

FIG. 6 shows the % leaf consumption of the leaf tissure from corn treated with different film-coats.

FIG. 7 shows the total amount of dust-off per 100 000 seeds submitted to a 2-minute Heubach test.

FIG. 8 shows the dust for different film-coat formulations tested on cord.

FIG. 9 shows corn abrasion scores determined after 4 min Heubach tests.

FIG. 10 shows dry flow of soybeans through a funnel for different film-coat formulations.

FIG. 11 shows the wet and dry flow of corn through a funnel for different film-coat formulations.

### DETAILED DESCRIPTION

It was surprisingly found that the seed coating composition and use of the pre-blend of the invention allows for improved bio-efficacy of the active ingredient. Active ingredients were better released from the seed coating to perform their desired effect, causing better bio-efficacy. At the same time, the seed coating compositions of the invention surprisingly are able to retain desirable seed coating properties such as water-permeability, good abrasion resistance, low dust emissions, short drying time, good flow ability and plant ability, low clumping, good cosmetics and/or coverage.

The term “seed” as used in this application is meant to refer in particular to the ripened ovule of gymnosperms and angiosperms, which contains an embryo surrounded by a protective cover. In particular, the term covers cereal kernels. The protective cover can comprise the seed coat (testa). Some seeds comprise a pericarp or fruit coat around the seed coat. In particular, when this layer is closely adhered to the seed, as in cereal kernels, it is in some cases referred to as a caryopsis or an achene. As used in this application, the term “seed coat” is meant to include a caryopsis or an achene. In practical terms, the term “seed” includes but is not restricted to anything that can be planted in agriculture to produce plants, including pelleted seeds, true seeds, plant seedlings, rootstock, regenerable and plant forming tissue, and tubers or bulbs.

The term “coating” as used in this application, is meant to refer to applying material to a surface of a seed, for instance as a layer of a material around a seed. Coating includes film coating, pelleting, and encrusting or a combination of these techniques. Pellets obtained with pelleting are also known as seed pills. The coating is preferably applied over substantially the entire surface of the seed, such as over 90% or more of the surface area of the seed, to form a layer. However, the coating may be complete or partial, for instance over 20% or more of the surface area of the seed, or 50% or more.

The term “seed coating composition” as used in this application is meant to refer to an aqueous composition to be used for coating of seed.

The term “pre-blend” as used in this application is meant to refer to an aqueous composition which is formed prior to adding the other components of the seed coating composition, i.e. is in a stable emulsion and/or dispersion form. The pre-blend is preferably formed in a different location to the seed coating composition.

The term “different location” as used in this application is meant in different mixing vessels, preferably in different buildings or premises, more preferably at least 5 miles apart. Thus, the pre-blend is preferably prepared by mixing the relevant individual components, then packaged, stored and/or transported and only thereafter combined with the other components, including formulations of plant enhancing agents, to form the seed coating composition.

The term “plant enhancing agent” as used in this application is meant to refer to any component that is directly or indirectly advantageous for a plant or a plant seed, for instance through a biological effect on the plant, seed, or on organisms harmful for a plant such as fungi, pests and insects. Plant enhancing agents include plant protective products, safeners, growth promoters, growth regulators, and the like.

The term “hydrophobic and/or water insoluble” as used in this application is meant to describe materials that are primarily non-polar and exhibit limited or no dissolution in water. However, such materials can be suspended in water as molecules or particles.

The seed is a plant seed, for example a seed of an agricultural crop, a vegetable seed, a herb seed, a wildflower seed, an ornamental seed, a grass seed, a tree seed, or a bush seed.

Preferably, the plant seed is of an agricultural crop. The seed may be of the order of Monocotyledoneae or of the order of Dicotyledoneae. Suitable seeds include seed of soybean, cotton, corn, peanut, maize, wheat, barley, oat, rye triticale, mustard, oil seed rape (or canola) sunflower, sugar beet, safflower, millet, chicory, flax, rapeseed, buckwheat, tobacco, hemp seed, alfalfa, signal grass, clover, sorghum, chick pea, beans, peas, vetch, rice, sugar cane, and linseed. Examples of suitable vegetable seeds include asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, water melon, melon, cucumber, gherkin, marrow, parsley, fennel, pea, beans, radish, black salsify, eggplant, sweet corn, pop-corn, carrot, onion, tomato, pepper, lettuce, snap bean, cucurbit, shallot, broccoli, Brassica, and Brussels sprout.

Preferably, the plant seed is capable of germinating. Optionally, the seed may be deprived of husk (so-called husked seed or de-hulled seed). The seed may be primed or not primed (having been subjected to a treatment to improve the germination rate, e.g. osmopriming, hydropriming, matrix priming).

The wax used in the present invention may be selected from the group consisting of natural wax, mineral wax and synthetic wax or a combination thereof. Preferably, the wax is selected from the group consisting of polyethylene wax, carnauba wax, paraffin wax, polypropylene wax, oxidised polyethylene wax, montan wax, ceresin wax, ozocerite, peat wax, Fischer-Tropsch wax, amide wax, ethylene-acrylic acid wax, polyolefin wax, ethylene bis stearamide wax, bees wax, lanolin wax, sugar cane wax, palm wax, and vegetable wax. It is also possible that mixtures of two or more waxes are present in the seed coating composition and/or pre-blend of the invention. In a preferred embodiment, the wax is selected from the group consisting of polyethylene wax, Fischer-Tropsch wax, and carnauba wax. The wax can be an anionic wax, a non-ionic wax or a cationic wax. Most preferably, the wax can be anionic or non-ionic. Cationic waxes may give rise to flocculation problems when the seed coating composition is combined with anionically stabilised active ingredients.

The wax used in the invention is preferably in the form of an aqueous emulsion, preferably of polyethylene wax or Fischer-Tropsch wax, more preferably Fischer-Tropsch wax. The amount of wax in the aqueous emulsion is suitably in the range from 20-60%, preferably 30-50%, more preferably 38-46%, particularly 40-44%, and especially 41-43% by weight based on the total weight of the emulsion.

The seed coating composition comprises one or more biologically active ingredients (including plant enhancing agents, in particular plant protective products (also referred to as PPPs). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides. Further possible active ingredients include disinfectants, micro-organisms, rodent killers, weed killers (herbicides), attracting agents, (bird) repellent agents, plant growth regulators (such as gibberellic acid, auxin or cytokinin), nutrients (such a potassium nitrate, magnesium sulphate, iron chelate), plant hormones, minerals, plant extracts, germination stimulants, pheromones, biological preparations, etc.

In an embodiment, the one or more active ingredients comprise at least one hydrophobic and/or water insoluble active ingredient.

The amount of active ingredient applied, of course, strongly depends on the type of active ingredient and the type of seed used. Usually, however, the amount of one or more active ingredients is in the range of 0.001-200 g per kg of the seed. The skilled person is able to determine suitable amounts of active ingredient depending on the active ingredient and the type of seed used. It is common practice for the skilled person to use and follow the advice of the active ingredient suppliers (e.g., BASF, Bayer, Syngenta, DuPont, etc.), such as by using technical data sheets and/or follow recommendations.

Typical fungicidal agents include Captan (N-trichloromethyl)thio-4-cyclohexane-1,2-dicarboximide), Thiram tetramethylthioperoxydicarbonic diamide (commercially available as Proseed™), Metalaxyl (methyl-N-(2,6-dimethylphenyl)-N-(methoxyacetyl)-d,1-alaninate), Fludioxonil (4-(2,2-difluoro-1,3-benzodioxol-4-yl)-1-H-pyrrol-3-carbonitril; commercially available in a blend with mefonoxam as Maxim™ XL), difenoconazole (commercially available as Dividend™ 3FS), carbendazim iprodione (commercially available as Rovral™, ipconazole (commercially available as Rancona from Arista, formerly Agriphar or Chemtura), mefonoxam (commercially available as Apron™ XL), tebuconazole, carboxin, thiabendazole, azoxystrobin, prochloraz, prothioconazole (commercially available as Redigo from Bayer), sedaxane (commercially available as Vibrance from Syngenta), cymoxanil (1-(2-cyano-2-methoxyiminoacetyl)-3-ethylurea), fludioxonil, a mixture of metalaxyl, cymoxanil and fludioxonil commercially available as Wakil from Syngenta, and oxadixyl (N-(2,6-dimethylphenyl)-2-methoxy-N-(2-oxo-3-oxazolidinyl) acetamide). A fungicide can be included in the seed coating composition in an amount of 0.0001-10% by total weight of the coated seeds.

Typical bactericidal agents include streptomycin, penicillins, tetracyclines, ampicillin, and oxolinic acid.

Typical insecticidal agents include pyrethroids, organophosphates, caramoyloximes, pyrazoles, amidines, halogenated hydrocarbons, neonicotinoids, and carbamates and derivatives thereof. Particularly suitable classes of insecticides include organophosphates, phenylpyrazoles and pyrethoids. Preferred insecticides are those known as terbufos, chlorpyrifos, fipronil, chlorethoxyfos, tefluthrin, carbofuran, imidacloprid, and tebupirimfos. Commercially available insecticides include imidacloprid (commercially available as Gaucho™), and clothianidin (commercially available from Bayer as Poncho™), thiametoxam (commercially available from Syngenta as Cruiser™), thiacloprid (commercially available as Sonido from Bayer), Cypermetrin (commercially available from Chemtura as Langis®), methiocarb (commercially available as Mesurol from Bayer), fipronil (commercially available from BASF as Regent™), chlorantraniliprole (also known as rynaxypyr, 5-bromo-N-[4-chloro-2-methyl-6-(methylcarbamoyl)phenyl]-2-(3-chloropyridin-2-yl)pyrazole-3-carboxamide, commercially available as Coragen® from DuPont) and cyantraniliprole (also known as cyazypyr, 3-bromo-1-(3-chloro-2-pyridyl)-4′-cyano-2′-methyl-6′-(methylcarbamoyl)pyrazole-5-carboxanilide).

An additional class of insecticidal agents includes RNAi (RNA interference) type of molecules which have been shown, for example, to control insect pests upon ingestion of specific RNAi molecules.

Commercially available nematicidal agents include abamectin (commercially available from Syngenta as Avicta™) thiodicarb (commercially available from Bayer as Aeris™).

Typical molluscicidal agents include metaldehyde (commercially available from Lonza as Meta®) or niclosamid (commercially available from Bayer as Bayluscide®), Cyazypir and Rynaxypir (available from DuPont).

Examples of suitable biologicals include bacilli, Trichoderma, rhizobia (for nitrogen fixation) and the like, which have been identified as seed treatment materials to protect plants and/or enhance their health and/or productive capacity. The use of seed coating compositions of the invention can result in improved viability of these biologicals.

These lists are not exhaustive, new active ingredients are continuously developed and can be incorporated in the seed coating composition.

The pigment used in the present invention is preferably an inorganic material and may, for example, be an effect pigment and/or a colored pigment as known in the art.

Examples of suitable effect pigments include pearlescent pigment in different particle sizes. Effect pigments having a particle size of 15 μm or less, or a particle size of 60 μm or less may be used. The particle size of the effect pigment is preferably not more than 200 μm, more preferably not more than 100 Usually, the particle size of the effect pigment is 1 μm or more. Another effect pigment can be aluminium. Effect pigments can be used to create an attractive cosmetic look on the seeds.

Examples of colored pigments include pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793-37-8), and pigment white 6 (CAS No. 98084-96-9). The particle size of the colored pigment is preferably not more than 100 more preferably not more than 50 μm. Usually, the particle size of the colored pigment is 25 μM or more.

A dye such as anthraquinone, triphenylmethane, phthalocyanine, derivatives thereof, and diazonium salts, may be used in addition to or as an alternative to a colored pigment.

The seed coating composition and/or pre-blend of the invention may also comprise a surface active agent such as a wetting, dispersing and/or emulsifying agent. The surface active agent may aid in mixing/emulsifying/dispersing the wax and/or pigment particles in the pre-blend and seed coating composition. Suitable surface active agents include ionic and non-ionic products and include solutions of organo-modified polyacrylates, polyacrylates, sodium polyacrylate, polyurethane, phosphoric acid ester, star polymers, and/or modified polyethers.

One preferred surface active agent is a graft or comb copolymer comprising an acrylic backbone with polyethylene glycol (PEG) side chains. The acrylic backbone may be formed from acrylic acid, methacrylic acid, methyl acrylate, ethyl acrylate, methyl methacrylate and/or ethyl methacrylate, preferably from methyl methacrylate and methacrylic acid. The surface active agent suitably has a molecular weight in the range 20,000 to 30,000 Daltons.

The seed coating composition and/or pre-blend of the invention may comprise further components such as one or more selected from a filler, a solvent, a thickener, an anti-foaming agent, a preservative, and a slip additive.

One surprising feature of the present invention is that the advantageous properties of the seed coating composition can be obtained in the absence of any polymeric binder, particularly any synthetic polymeric binder, other than wax,

Thus, the amount of polymeric binder, preferably synthetic polymeric binder, other than wax in the seed coating composition and/or pre-blend is preferably 10% by weight or less based on the total weight of the wax, more preferably, the amount of polymeric binder other than wax is 8% by weight or less based on the total weight of the wax, such as 6% by weight or less, 4% by weight or less, 2% by weight or less, or 1% by weight or less. More preferably, the seed coating composition and/or pre-blend is essentially free from polymer binder other than wax. This means that other than wax essentially no polymeric binders are present in the seed coating composition and/or pre-blend. Trace amounts, though, may still be present, such as amounts of 0.1% or less by total weight of the wax, or 0.05% or less. Most preferably, the seed coating composition and/or pre-blend is free from polymeric binder other than wax.

If a polymeric binder other than wax is present, then the binder may, for example, be selected from the group consisting of polyvinyl acetates, polyvinyl acetate copolymers, polyvinyl alcohols, polyvinyl alcohol copolymers, polyurethane, celluloses (including ethylcelluloses, methylcelluloses, hydroxymethylcelluloses, hydroxypropylcelluloses, carboxymethylcelluloses, and hydroxymethylpropylcelluloses), polyvinylpyrrolidones, dextrins, maltodextrins, starchs, polysaccharides, fats, oils, proteins, gum arabics, shellacs, vinylidene chloride, vinylidene chloride copolymers, calcium lignosulphonates, polyacrylates, acrylic copolymers, polyvinylacrylates, zeins, casein, gelatine, chitosan, pullulan, polyethylene oxide, polyethylene glycol, ethylene vinylacetate, acrylamide polymers, acrylamide copolymers, polyhydroxyethyl acrylate, methylacrylimide monomers, poly(N-vinylacetamide), sodium alginate, polychloroprene and syrups. These binders may be used alone or in combination of two or more. Preferred binders can be selected from the group consisting of polyvinyl acetates, polyvinyl alcohols, hydroxypropylmethylcellulose, polysaccharides, proteins, polyethylene glycol, polyvinyl pyrrolidones, and polyacrylates.

Suitable thickeners include agar, carboxy methylcellulose, carrageen, chitin, fucoidan, ghatti, gum arabic, karaya, laminaran, locust bean gum, pectin, alginate, guar gum, xanthan gum, diutan gum, and tragacanth, bentonite clays, HEUR (hydrophobically modified, ethoxylated urethane) thickeners, HASE (hydrophobically modified, alkali-swellable emulsion) thickeners and polyacrylates. Gums are generally preferred because of their low cost, availability and superior ability to enhance the physical characteristics of the resultant film.

Examples of suitable antifoaming agents include polyethylene glycol, glycerine, mineral oil defoamers, silicone defoamers, and non-silicone defoamers (such as polyethers, polyacrylates), dimethylpolysiloxanes (silicone oils), arylalkyd modified polysiloxanes, polyether siloxane copolymer containing fumed silica. The antifoaming agent may be present in some embodiments of the seed coating composition in an amount of at least 1 ppm by weight, or 0.1-0.3% by total weight of the seed coating composition.

A biocide can be included in some embodiments of the seed coating composition and/or pre-blend for instance as preservative, in order to prolong the shelf life of the seed coating composition before being applied to a seed, such as when being stored. Examples of suitable biocides include MIT (2-methyl-4-isothiazolin-3-one; CAS No. 2682-20-4), BIT (1,2-benzisothiazolin-3-one; CAS No. 2632-33-5)), CIT (5-Chloro-2-methyl-4-isothiazolin-3-one), Bronopol (2-Bromo-2-nitro-propane-1,3-diol) and/or a combination of these.

In an embodiment, the seed coating composition and/or pre-blend further comprises flakes of a translucent polymeric film on an inert carrier (a carrier which has no detectable, harmful consequences for the environment, in particular for the seed or the outgrowing plant in the quantities present) for providing the seeds with a light-reflecting appearance, such as described in WO-A-03/003812. Preferably, the translucent polymeric film comprises light-reflecting particles.

The seed coating composition and/or pre-blend may further comprise one or more solvents other than water. Solvents may be selected from the group consisting of alcohols, and hydrocarbons. Also mixtures of solvents can be used. It is preferred that the solvent is liquid at 20° C. and 1 atm. Examples of suitable solvents include glycols and their esters and ethers, in particular ethylene and propylene glycols and their esters and ethers, for instance, esters and ethers with C₁-C₆ alkyl groups and/or aromatic groups, such as methyl, ethyl, propyl, butyl, benzyl and phenyl ethers, including mono ethers and dialkyl ethers, and esters of these ethers, such as acetates, and ethylene and propylene glycol esters, for instance of fatty acids; polyethylene glycol (PEG) and polypropylene glycol and esters thereof, especially with fatty acids; butyl cellosolve, butyl carbitol, polyethylene glycol; N-methylpyrrolidone, glycerine, alkyl alcohols with up to 10 carbon atoms, such as ethanol, propanol and butanol. Other examples of solvents include dipropylene glycol methyl ether and propylene glycol methyl ether. An important solvent is ethylene glycol. Further examples include propylene tetramer and synthetic ester oils such as lactate esters, particularly ethyl lactate and benzoate esters e.g. iso-propyl or 2-ethylhexyl benzoates. Aromatic hydrocarbons such as xylene, aliphatic and paraffinic solvents and vegetable oils can also be used as solvent. Aromatic solvents are less preferred.

The seed coating composition and/or pre-blend may also comprise components with a plasticising effect, such as surfactants or antifreeze agents. Common surfactants include amphiphilic organic compounds, usually comprising a branched, linear or aromatic hydrocarbon, fluorocarbon or siloxane chain as tail and a hydrophilic group. Some types of surfactants include non-ionic, anionic, cationic and amphoteric surfactants, and organosilicone and organofluorine surfactants. Some examples of surfactants include polyoxyethylene glycol and polyoxypropylene ethers and esters, in particular alkyl, aryl and alkylaryl ethers thereof, and sulphates, phosphates and sulphonic acid compounds of such ethers, glucoside (alkyl) ethers, glycerol esters, such as alkyl and fatty acid esters, sorbitan (alkyl) esters, acetylene compounds, cocamide compounds, block copolymers of polyethylene glycol and propylene glycol. Further examples of surfactants include alkylamine salts and alkyl quaternary ammonium salts, for example betain type surfactants, amino acid type surfactants; and polyhedric alcohols, fatty acid esters, in particular C₁₂-C₁₈ fatty acids, for instance of polyglycerin, pentaerythritol, sorbitol, sorbitan, and sucrose, polyhydric alcohol alkyl ethers, fatty acid alkanol amides, and propoxylated and ethoxylated compounds such as fatty alcohol ethoxylates, polyethyxlated tallow amine and alkylphenol ethoxylates. Some examples of anionic surfactants include carboxylic acids, copolymers of carboxylic acids, sulphates, sulphonic acid compounds and phosphates, for example lignin sulphonates and (linear) alkylaryl sulphonates.

Anti-freeze agents include for example: ethylene glycol, propylene glycol, 1,3-butylene glycol, hexylene glycol, diethylene glycol, and glycerin, with the preferred glycol being ethylene glycol and propylene glycol.

In an embodiment, an aqueous pre-blend is formed which comprises, consists essentially of, or consists of, a wax, at least one pigment, and an optional surface active agent, preferably all as defined herein. Optional minor components of the pre-blend comprise, consist essentially of, or consist of a preservative or biocide and/or rheology modifier. By minor component is meant preferably present in an amount of less than 0.5%, more preferably less than 0.3%, and particularly less than 0.2% by weight based on the total weight of the pre-blend. The pre-blend is preferably used as one component of the seed coating composition.

The amount of wax, preferably in the form of an aqueous emulsion of Fischer-Tropsch wax, in the pre-blend is suitably in the range from 30-95%, preferably 40-85%, more preferably 50-75%, particularly 57-65%, and especially 60-62% by weight based on the total weight of solids in the pre-blend.

The amount of pigment, preferably effect pigment, in the pre-blend is suitably in the range from 5-70%, preferably 15-60%, more preferably 30-50%, particularly 34-40%, and especially 36-38% by weight based on the total weight of solids in the pre-blend.

The ratio of wax to pigment in the pre-blend is suitably in the range from 0.4-5:1, preferably 1.0-3.0:1, more preferably 1.3-2.0:1, particularly 1.5-1.8:1, and especially 1.6-1.7:1 by weight.

The amount of surface active agent, preferably a graft copolymer comprising an acrylic backbone with PEG side chains, in the pre-blend is suitably in the range from 0-5%, preferably 0.4-3.5%, more preferably 1.0-2.5%, particularly 1.6-2.0%, and especially 1.7-1.9% by weight based on the total weight of solids in the pre-blend.

The pre-blend preferably comprises (i) solids in an amount suitably in the range from 30-80%, preferably 40-70%, more preferably 45-63%, particularly 51-57%, and especially 53-55% by weight based on the total weight of the pre-blend, and/or (ii) water in an amount suitably in the range from 20-70%, preferably 30-60%, more preferably 37-55%, particularly 43-49%, and especially 45-47% by weight based on the total weight of the pre-blend.

In an embodiment, the seed coating composition is formed by combining or mixing together (i) the pre-blend defined herein, (ii) one or more biologically active, preferably hydrophobic or water insoluble, ingredients defined herein, (iii) a dye or pigment defined herein, preferably colored pigment, and (iv) optionally diluting with water.

The amount of pre-blend in the seed coating composition is suitably in the range from 5-50%, preferably 10-35%, more preferably 15-30%, particularly 19-25%, and especially 21-23% by weight based on the total weight of the composition.

The amount of pigment, preferably colored pigment, in the seed coating composition, not including any pigment in the pre-blend, is suitably in the range from 1-14%, preferably 2-12%, more preferably 3-10%, particularly 4-8%, and especially 5-6% by weight based on the total weight of the composition.

The ratio of pigment, preferably effect pigment, in the pre-blend to pigment, preferably colored pigment, added separately from the pre-blend, in the seed coating composition is suitably in the range from 0.3-3.0:1, preferably 0.5-2.0:1, more preferably 0.7-1.5:1, particularly 0.8-1.2:1, and especially 0.9-1.1:1 by weight.

The total amount of pigment (effect and/or colored pigment) in the seed coating composition is suitably in the range from 5-30%, preferably 8-20%, more preferably 9-17%, particularly 11-15%, and especially 12-14% by weight based on the total weight of the composition.

The amount of wax in the seed coating composition is suitably in the range from 2-20%, preferably 4-12%, more preferably 5-10%, particularly 6-9%, and especially 7-8% by weight based on the total weight of the composition.

The amount of one or more biologically active, preferably hydrophobic and/or water soluble, ingredients in the seed coating composition is suitably in the range from 0-5.0%, preferably 0.1-2.5%, more preferably 0.2-1.0%, particularly 0.3-0.8%, and especially 0.4-0.6% by weight based on the total weight of the composition.

The seed coating composition of the invention may be applied to the seed in a conventional manner.

In an embodiment, the seed is not provided with artificial layers prior to applying the seed coating composition, for example layers comprising a binder, such as a polymer. Accordingly, the seed coating composition is preferably applied directly on the natural outer surface of the seed. Nonetheless, it is possible that the seed surface has undergone a surface treatment prior to applying the seed coating composition. It is possible that such surface treatment does not entail the provision of an artificial layer, but involves a physical change or modification of the surface of part of the seed or the entire surface of the seed. For example, the surface treatment may involve increasing the surface roughness of the seed, such as by selective removal of parts of the seed coat, selective deformation of the seed coat, or a combination thereof. Typically, the treatment may involve introducing micro roughness on the seed surface. It is also possible that the seed surface is subjected to a surface treatment that does involve the provision of an artificial layer, such as the application of a primer coating layer on the seed surface. Other suitable surface treatments include, e.g., plasma surface treatment, contacting the seed with an abrasive material, exposure to hot and humid air, flame treatment, laser treatment, and electron beam surface treatment.

Preferably, the coating composition is applied as a liquid composition and/or emulsion and/or dispersion and/or latex composition and thereafter solidified (including cured and/or dried) to form a seed coating. The term “liquid coating composition” as used in this application is meant to include coating compositions in the form of a suspension, emulsion, and/or dispersion, preferably an emulsion and/or dispersion.

Conventional means of coating may be employed for coating the seeds. Various coating machines are available to the person skilled in the art. Some well-known techniques include the use of drum coaters, fluidised bed techniques, rotary coaters (with and without integrated drying), and spouted beds. Suitably, the seed coating composition is applied to the seed by a rotary coater, a rotary dry coater, a pan coater or a continuous treater.

Typically, the amount of seed coating composition applied to the seed can be in the range of 0.5-50 g per kg seed, such as 1-40 g per kg seed, 2-35 g per kg seed, or 3-30 g per kg seed.

The seed coating composition can, for instance, be applied by film coating, spraying, dipping, or brushing of the seed coating composition. Optionally, it is applied at a temperature of −25° C. to 50° C., for instance −5° C. to 35° C., more often 15° C. to 30° C., for instance at room temperature, such as 18° C. to 25° C. Preferably, the seed coating composition is applied to the seed by film coating. The film coating may suitably be applied by spraying the liquid coating composition onto the seed, typically while the seeds fall or flow through a coating apparatus. Preferably, the method comprises film coating of the seed to apply the seed coating composition in the form of a film coating composition.

Seed coating typically involves forming on the surface of the seeds a firmly adhering, moisture-permeable coating. The process typically comprises applying a liquid seed coating composition to the seeds before planting.

### EXAMPLES

### Example 1

Film coating formulations were prepared according to table 1. A PPP (plant protection products) cocktail was used containing 52.7 wt. % hydrophobic insecticide and 47.3 wt. % fungicide. Soybean seeds were coated with a slurry of 43.1 wt. % PPP cocktail, 43.3 wt. % film coating formulations and 13.6 wt. % Color Coat Red (pigment concentrate from BASF); the application rate being 5.5 g/kg seeds, such that 2.38 g film coating formulation per kg seed was applied. A reference sample was prepared by coating soybean seeds with a slurry containing 43.1 wt. % PPP cocktail, 43.3 wt. % water and 13.6 wt. % Color Coat Red.

TABLE 1
Composition of film-coat formulations.

| | Film-Coat A | | Film-Coat B |
|---|---|---|---|
| | (% wt/wt) | | (% wt/wt) |
| water | 60 | wax emulsion | 78.59 |
| rheology additive | 0.2 | (42 wt %) | |
| defoamer | 0.1 | defoamer | 0.01 |
| biocide | 0.2 | surfactant | 1.0 |
| vinyl acetate binder | 25 | biocide | 0.2 |
| emulsion (50 wt %) | | rheology additive | 0.2 |
| white pigment | 5 | effect pigment | 20 |
| concentrate | | | |
| red pigment | 9.5 | | |
| concentrate | | | |

The release of the hydrophobic insecticide in water from coated soybean seeds was measured according to the following protocol. 6 treated soybean seeds were placed in a plastic centrifuge tube with 20 ml of deionised water. After one hour, the water was decanted off the seeds, sampled for LCMS analyses, and replaced by 20 ml of clean deionised water in the centrifuge tube containing the seeds. The same procedure was repeated after 2, 3, 4, 24 and 48 hours. Upon collecting the 48 hour water sample, the seeds were immersed into 10 ml of acetonitrile (AcN) to extract any residual active ingredient, all solvents were evaporated. Liquid Chromatrography Mass Spectrometry (LCMS) analyses were performed on the 1, 2, 3, 4, 24, 48 hours and AcN extraction samples. Samples were prepared by adding 2 ml of acetonitrile (containing 0.1 vol. % of trifluoroacetic acid) to the vials and shaking them at 40° C. for 30 minutes. Subsequently, 2 ml of deionised water (containing 0.1 vol. % of trifluoroacetic acid) were added, resulting in a total sample volume of 4 ml. These samples were shaken at 40° C. for 30 more minutes, after which they were filtered through a 0.2 microns filter.

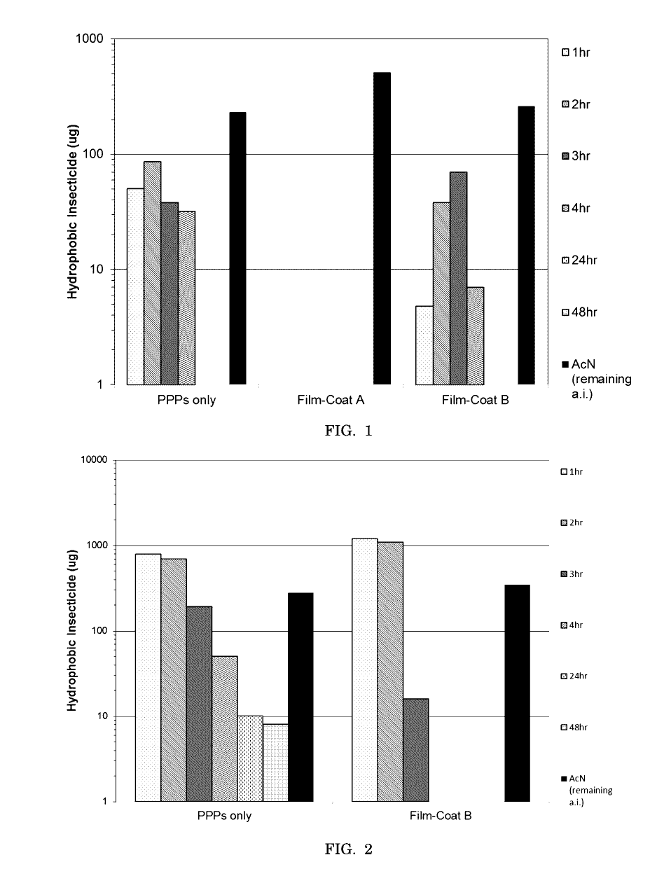

FIG. 1 shows the release patterns of the hydrophobic insecticide in water measured on coated soybean seeds. The release patterns of hydrophobic insecticide in water represented in FIG. 1 show that the reference soybean seeds sample coated without film-coat liquid displayed the fastest release profile. Using a standard film-coat formulation such as Film-Coat A, based on a polyvinyl acetate binder, resulted in no release of the active ingredient. Film-Coat B formulation, based a high content of wax, resulted in a fast release of the active in water and low residual hydrophobic insecticide on the seed at the end of the release test.

### Example 2

Film coating formulations were prepared according to tables 2 and 3. A PPP cocktail was used consisting of 45.2 wt. % hydrophobic insecticide, 47.3 wt. % insecticide and 7.5 wt. % fungicide. Corn seeds were coated with a slurry of 46.3 wt. % PPP cocktail, 2.7 wt. % Color Coat Red (pigment concentrate obtained from BASF), 19.4 wt. % film coating formulations, and 31.6 wt. % water; the application rate being 16.5 g/kg seeds, such that 3.20 g film coating formulation per kg seed was applied.

TABLE 3
Composition of film-coat formulations.

| | Film-Coat C | | Film-Coat D |
|---|---|---|---|
| | (% wt/wt) | | (% wt/wt) |
| wax emulsion | 74.0 | wax emulsion | 78.39 |
| (42 wt %) | | (42 wt %) | |
| defoamer | 0.05 | defoamer | 0.01 |
| surfactant | 0.75 | surfactant | 1.0 |
| biocide | 0.2 | biocide | 0.2 |
| effect pigment | 25 | rheology additive | 0.4 |
| | | effect pigment | 20 |

The release patterns of the hydrophobic insecticide in water from treated corn seeds were characterized following the same protocol as described in example 1, employing 6 coated corn seeds per test. FIG. 2 shows release patterns of hydrophobic insecticide in water measured on coated corn seeds. The hydrophobic insecticide release patterns in water from coated corn seeds displayed in FIG. 2 show again that the slurry treatment performed without film-coat formulation enabled a high release rate of the active in waters. Film-Coat B, based on a high wax content gave high release rates and residual amounts of active on the seeds similar to those obtained in the absence of film-coat formulation.

### Example 3

Soybean bioassays were performed by planting 12 seeds per treatment in a soil mixture composed of 51% silt, 29% clay, and 20% sand.

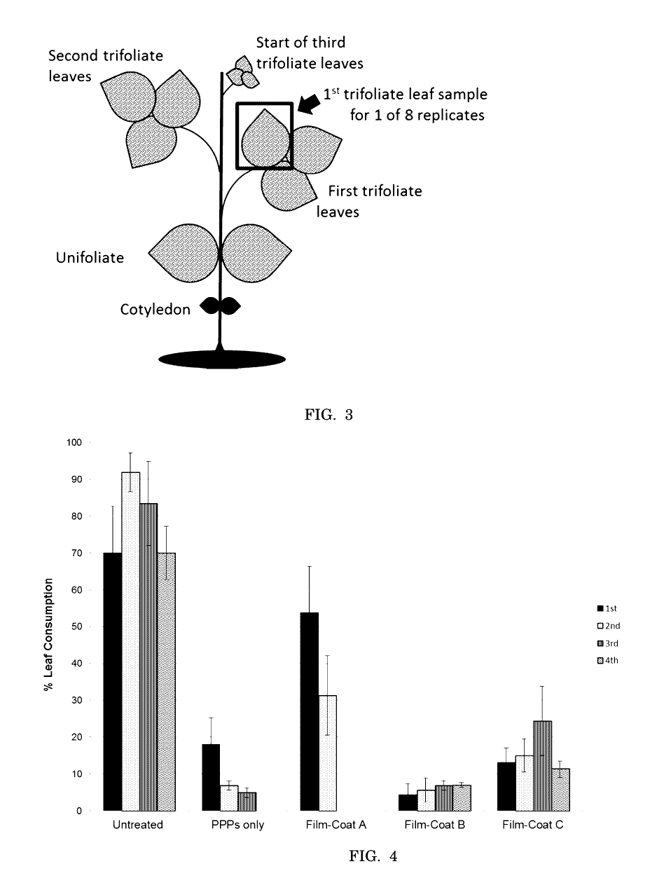

Plants were grown at about 20-25° C., exposed to 12 hours of light per day, watered daily, and fertilised once per week. At each relevant trifoliate (1^{st} through 4^{th}), 8 total leaves were clipped for each treatment type at the base of the leaf, taking only one leaf per plant. FIG. 3 shows the sampling procedure for 1^{st} trifoliate soybean leaves for a bioassay. Leaves were bioassayed by placing one soybean looper (Pseudoplusia includens) on one soybean leaf measuring 22 mm in diameter in a sealed tray at 25° C., where it was allowed to feed on leaf material for four days. At that time leaf consumption and insect mortality was noted for each sample, where each data point is an average of eight leaves of the same treatment.

FIG. 4 shows a comparison of % leaf consumption of the soybean leaf discs of various film-coats to that of untreated seeds and seeds treated with PPPs only. The positive control of untreated seeds show high leaf consumption and poor insect control, while the negative control of seeds treated with PPPs only show low leaf consumption and better insect control. Mirroring the release data, Film-Coat A shows relatively high leaf consumption, indicating that it is unable to successfully uptake the active into the plant and protect from insecticidal activity. Film-Coats B and C show low leaf consumption similar to that of the PPP alone seeds. Film-Coat B is the most effective at uptaking the actives and therefore controlling the insects, keeping leaf consumption under 10% up to 4^{th} trifoliate.

### Example 4

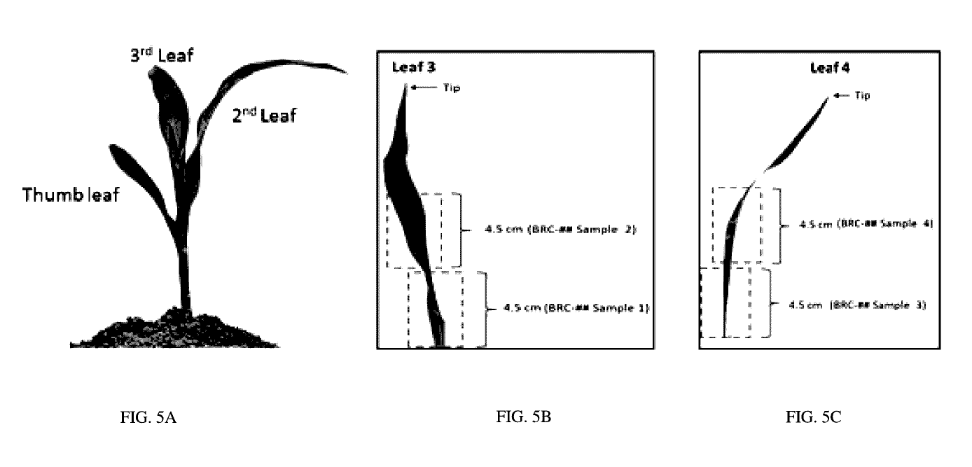

Corn bioassays were performed by planting 4 seeds per treatment in a soil mixture composed of 51% silt, 29% clay, and 20% sand. Plants were grown at about 20-25° C., exposed to 12 hours of light per day and watered daily. Typical period of plant growth consisted of three weeks from sowing to clipping of the leaves for bioassay. The leaves 3^{rf} and 4^{th} were clipped at the growth stage wherein, the fifth leaf was still in the whorl. The leaves were numbered as shown in the FIG. 5A. The 3^{rd} leaf was clipped at 3 cm from the base and further divided into two sections (Sample 1 & 2) for bioassay as shown in FIG. 5B. The 4^{th} leaf was clipped at the base and further sectioned into two parts as shown in the FIG. 5C. For each treatment, leaves from three plants were collected totaling 12 samples per treatment. Each of the samples (4.5 cm section) were then placed in separate bioassay trays and one 2^{nd} instar larvae of fall armyworm (Spodoptera frugiperda) was introduced to each tray. The trays were then sealed and placed at 25° C. for four days. After four days, the % leaf consumption for each treatment (12 samples) were averaged to compared the efficacy of the across various treatment.

FIG. 6 shows the % leaf consumption of the leaf tissue from corn treated with different film-coats. The lower the leaf consumption, higher is the efficacy of the coating in releasing the actives thereby leading to better insect control. Leaf tissue from Untreated Corn seeds was tested as the negative control resulting in very high leaf consumption. The actives without any film-coat was tested as the positive control owing to the fact that having no film-coat could effortlessly release the actives and improve uptake by the plant. Of the film-coats tested, Film-Coat B provided superior bioefficacy comparable to the positive control followed by Film-Coats D and then C. The high wax content in these film-coats provided faster release of actives from the coating and resulted in better uptake by plants.

### Example 5

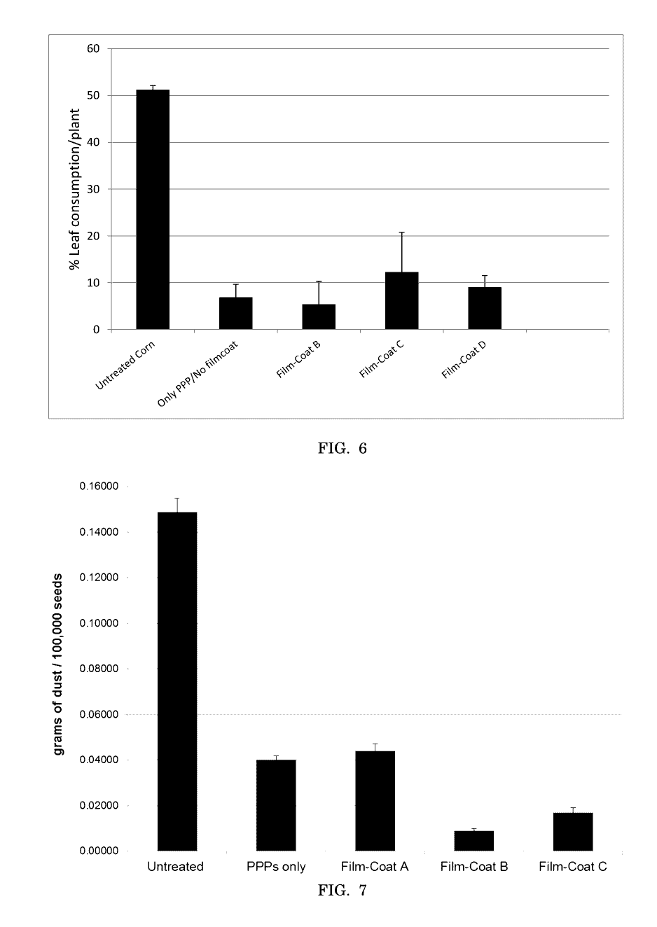

In addition to facilitating the uptake of actives, the new film coats are also able to reduce the amount of dust-off produced by soybeans. 100 grams of seeds were submitted to a 2-minute Heubach test in duplicate, averaging the results to a total amount of dust-off per 100 000 seeds (FIG. 7). In the case of soybeans, untreated seeds give off about 0.14897 g of dust per 100 000 seeds, which can be reduced about 4-fold when the seeds are treated with PPPs alone or traditional Film-Coat A. Use of the wax-based Film-Coat B and Film-Coat C, however, result in a further 4.5 and 2 fold decrease in dust, respectively, from that of PPP alone treated seeds.

### Example 6

If not carefully treated, seeds coated with actives and other enhancements result in harmful levels of dust during handling and processing of huge quantities of seeds. One of the primary objectives of a film-coating is to retain the actives on the seed and reduce dust while in operation. In addition to improving bioefficacy, the film-coats were also tested for dust reduction and abrasion resistance. Dust and abrasion data for corn treated with film-coats were obtained by following industry standards. Specific amount of seeds were placed in the Heubach apparatus and tested for 4 minutes. The dust collected on the filter paper was gravimetrically measured to evaluate different film-coat formulation.

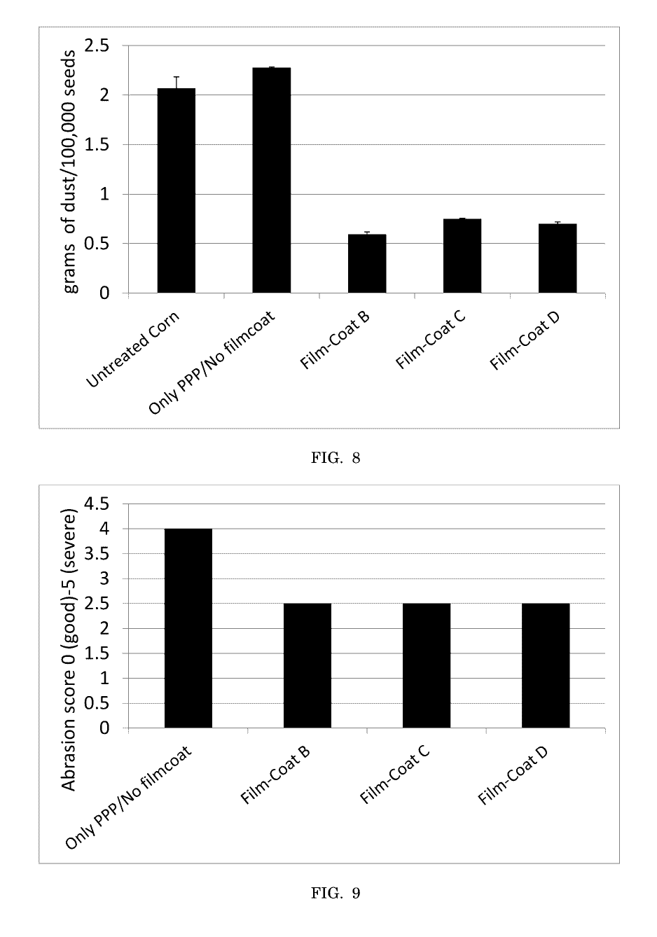

FIG. 8 shows the dust (g/100 000 seeds) for the different film-coat formulations tested on corn. Film-Coat B showed about 75% lower dust when compared to PPP alone. Film-Coats C and D showed statistically similar dust levels reducing dust about 60-65% more than PPP alone.

Abrasion on the corn seed was visually observed after the dust experiment in the Heubach apparatus. The abrasion score is a visual quantification of the quality of seeds after subjecting them to 4 minutes in the Heubach apparatus closely simulating handling conditions in the industry. The abrasion score was allocated from 1 (high abrasion resistance/good quality seeds) to 5 (low abrasion resistance/poor quality seeds). All of the film-coat formulations showed abrasion score of 2-2.5, while seeds with only PPP/no film-coat showed high abrasion and poor quality seeds. FIG. 9 shows corn abrasion scores determined after 4 min Heubach tests (1: high abrasion resistance; 5: poor abrasion resistance).

### Example 7

Rate of drying of seeds is another important feature that is considered when choosing film-coat. The rate of drying is checked by using a cotton indicator. The coated seeds, after exiting the coater are collected in a flat tray and a timer is activated. The drying is checked every 5-10 s by placing a fresh cotton indicator at a new seeds' surface in the seed tray each time. The moment there is no sign of color transfer on the cotton indicator from the seed, the timer is stopped and the time is recorded

Clumping/Bridging of seeds takes place when wet seeds exiting out of the coater are collected in the storage hopper and compacted by oncoming seeds. This presents a challenge to the seed treatment facility in terms of equipment blocking, labor and time. The film-coats described in this embodiment show faster drying times and minimal to no clumping.

The new film coats minimise dry time, tack, and clumping on soybeans. Use of traditional Film-Coat A and PPP alone treated seeds result in longer dry time, noticeable tack upon exiting the coater, and clumping after being allowed to sit under 1 kg of weight for 5 minutes. The new film-coats allow for a noticeably faster dry time, decrease in tackiness upon exiting the coater, and an elimination of clumping all together (table 4).

TABLE 4
Comparison of dry time, tack and clumping
of film-coats on soybeans.

| | Dry to touch | | |
|---|---|---|---|
| | (seconds) | Tack | Clumping |
| PPPs only | 48 | Yes | Minimal |
| Film-Coat A | 49 | Yes | Yes |
| Film-Coat B | 27 | Minimal | None |
| Film-Coat C | 29 | Minimal | None |

Dry flow of soybeans was measured as the time it took for 1 kg of seeds to flow through a funnel. Typically, the addition of PPPs and traditional film-coats to soybeans slows down the flow of seeds considerably (FIG. 10), which is not a desired characteristic. In fact, the addition of Film-Coat A to soybean seeds decreased flow more than a full second compared to untreated seeds. Film-Coats B and C are able to effectively decrease flow time considerably, with Film-Coat B allowing flow almost as fast as untreated seeds.

### Example 8

Rate of drying of seeds is another important feature that is considered when choosing a film-coat. The rate of drying is checked by using a cotton indicator. The coated seeds, after exiting the coater is collected in a flat tray and a timer is activated. The drying is checked every 5-10 s by placing a fresh cotton indicator at a new seeds surface in the seed tray each time. The moment there is no sign of colour transfer on the cotton indicator from the seed, the timer is stopped and the time is recorded.

Clumping/Bridging of seeds takes place when wet seeds exiting out of the coater are collected in the storage hopper and compacted by oncoming seeds. This presents a challenge to the seed treatment facility in terms of equipment blocking, labor and time. The film-coats described in this embodiment show faster drying times and minimal to no clumping.

TABLE 5
Comparison of dry time, tack and clumping of film coats on corn.

| | Dry to touch | |
|---|---|---|
| | (seconds) | Clumping |
| Only PPP/No | 24.25 | Yes |
| film-coat | | |
| Film-Coat B | 5.01 | None |
| Film-Coat C | 13.53 | Minimal |
| Film-Coat D | 24.07 | None |

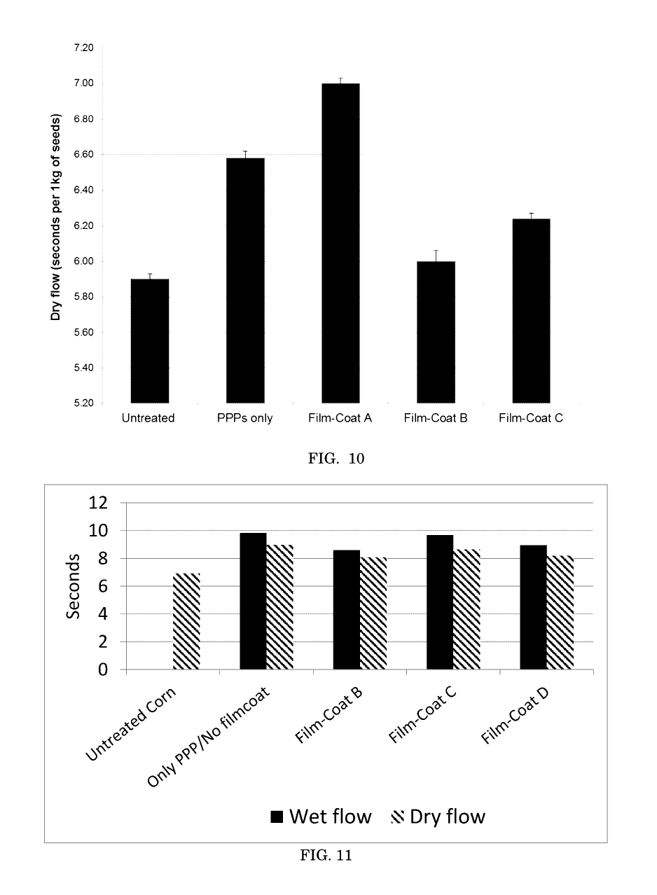

The flow of treated/coated seeds is important at the seed treating facility as well as at the farm whilst going through the planter. Lower the friction between the seeds, better is the efficiency at various stages. Flow is typically improved by incorporating a flow agent or a slip agent into the film-coat formulation. A flow agent is typically a wax-based additive that lowers friction and improves the appearance of the seed. For the testing the flow of treated seeds, 1 kg of seeds are placed in a funnel fitted with a stopper. The stopper is opened and timer started simultaneously. The time taken for the last seed to exit the funnel is recorded as the flow rate in (s/kg). The results are shown in FIG. 11 and illustrate the improved flow properties of the coated seeds according to the invention.

1. An aqueous seed coating composition comprising a wax, at least one pigment, an optional surface active agent and one or more biologically active ingredients.

2. The seed coating composition according to claim 1, wherein the wax is selected from the group consisting of polyethylene wax, Fischer-Tropsch wax, and carnauba wax.

3. The seed coating composition according to claim 1, comprising an effect pigment and a color pigment.

4. The seed coating composition according to claim 3, wherein the total amount of pigment is 11-15% based on the total weight of the composition.

5. The seed coating composition according to claim 1 wherein the amount of wax is 5-10% by weight based on the total weight of the composition.

6. The seed coating composition according to claim 1 comprising at least one hydrophobic and/or water insoluble biologically active ingredient.

7. The seed coating composition according to claim 1 wherein the biologically active ingredient comprises bacteria.

8. The seed coating composition according to claim 1 comprising substantially no polymeric binder other than wax.

9. A method of forming a seed coating composition which comprises combining (i) an aqueous pre-blend comprising a wax, at least one first pigment, and an optional surface active agent, (ii) one or more biologically active ingredients, (iii) a dye and/or second pigment different to the first pigment, and (iv) optionally water.

10. The method according to claim 9 wherein the wax in the pre-blend is selected from the group consisting of polyethylene wax, Fischer-Tropsch wax, and carnauba wax.

11. The method according to claim 9 wherein the first pigment is an effect pigment and the second pigment is a colored pigment.

12. The method according to claim 9 wherein (i) the amount of wax in the pre-blend is 40-85% by weight based on the total weight of solids in the pre-blend, (ii) the amount of pigment in the pre-blend is 15-60% by weight based on the total weight of solids in the pre-blend, and/or (iii) the ratio of wax to pigment in the pre-blend is 1.3-2.0:1 by weight.

13. The method according to claim 9 wherein the seed coating composition comprises at least one hydrophobic and/or water insoluble biologically active ingredient.

14. The method according to claim 9 wherein the amount of surface active agent in the pre-blend is 0.4-3.5% by weight based on the total weight of solids in the pre-blend.

15. The method according to claim 9 wherein the amount of wax in the seed coating composition is 4-12% by weight based on the total weight of the composition.

16. The method according to claim 9 wherein the amount of pre-blend in the seed coating composition is 5-30% by weight based on the total weight of the composition.

17. A seed with a coating comprising a wax, at least one pigment, an optional surface active agent and one or more biologically active ingredients.

18. The seed according to claim 17 wherein the coating is formed by applying a seed coating composition formed according to the method of claim 9.

19. An aqueous pre-blend comprising a wax, at least one pigment, and an optional surface active agent.

20. The pre-blend according to claim 19 wherein (i) the amount of wax in the pre-blend is 40-85% by weight based on the total weight of solids in the pre-blend, (ii) the amount of pigment in the pre-blend is 15-60% by weight based on the total weight of solids in the pre-blend, and/or (iii) the ratio of wax to pigment in the pre-blend is 1.3-2.0:1 by weight.

21. The pre-blend according to claim 19 comprising substantially no polymeric binder other than wax.

22. A method for improving the bio-efficacy and/or systemic uptake by plants of one or more active ingredients in a seed coating composition, comprising preparing a seed coating composition comprising a wax, at least one pigment, an optional surface active agent and one or more biologically active ingredients, and applying said seed coating composition to the seed.
